(19) United States
(12) Patent Application Publication
(10) Pub. No.: US 2019/0315634 A1
(43) Pub. Date: Oct. 17, 2019

(54) WATER RECLAIM METHOD AND SYSTEM

(71) Applicant: Edward A. Bray, San Juan, PR (US)

(72) Inventor: Edward A. Bray, San Juan, PR (US)

(21) Appl. No.: 16/453,286

(22) Filed: Jun. 26, 2019

Related U.S. Application Data
(63) Continuation-in-part of application No. 14/627,070, filed on Feb. 20, 2015.

(51) Int. Cl. C02F 1/00; C02F 1/44; C02F 1/52

(52) U.S. Cl. CPC C02F 1/008; C02F 2103/023; C02F 1/5209; C02F 1/444

(57) ABSTRACT

An apparatus and method for water collection, treatment, and/or reutilization. A water recovery method using at a water conditioning/precipitation equipment and least a filtration equipment. The water recovery system may further include an automation, monitor, and control system for automating, monitoring, and/or controlling, for example, the flow of wastewater, minerals at the water, the end use of the wastewater, etc.

### STATEMENT REGARDING FEDERALLY SPONSORED RESEARCH AND DEVELOPMENT

N/A

### RELATED APPLICATIONS

The present application claims the benefit of priority of U.S. provisional application 61/942,050, filed on Feb. 20, 2014, and U.S. application Ser. No. 14/627,070, filed on Feb. 20, 2015.

### BACKGROUND OF THE INVENTION

### Field of the Invention

The present disclosure relates to a water reclaim system and method for the treatment of wastewater from cooling equipment or boiler, such as a cooling tower, more particularly to an apparatus and method to separate contaminants from wastewater before reaching the sewers or to provide water which may be reused as water for the cooling tower or boiler.

### Discussion of the Background

Water, which is used to cool many of the areas or devices within buildings and facilities has become an expensive resource. Therefore, reducing water use can lower operational costs for a building and benefit the environment.

Further, water is available from cooling towers through evaporation and drift losses. The water drained from cooling equipment is called “blow-down” water or “bleed” water. Examples of cooling equipment that requires blow-down are cooling towers and boilers. Unfortunately, the minerals content on the remaining water increases in concentration of minerals as the water evaporates. The blow-down water containing minerals will cause scaling on equipment surfaces; possibly damaging the system. Typically, the blow-down water is usually dumped into the sanitary drain or/and drained into sewer lines, but the mineral content has to be in compliance with the environmental laws.

Thus, it can be appreciated from the foregoing that a system for water collection, treatment, and/or reutilization for certain end uses is desired. Furthermore, it is desirable a refrigeration/cooling system with a residue interceptor to contain effectively the residues flowing through the wastewater/blow-down before reaching the sewers and or recirculating said water into the system in order to provide water with an acceptable salinity or mineral content. Moreover, a method for the reclaiming of blow-down water is necessary, in order to reduce the amount of water that is discharged from a system and added to the system, therefore, lowering operational costs and benefit the environment.

### SUMMARY OF THE INVENTION

The present invention overcomes the disadvantages of the Prior Art providing a residue interceptor for a cooling and/or refrigeration systems, wherein said residue interceptors provide wastewater in compliance with current law requirements.

Another object of the invention is to provide a water reclaim system that is easily integrated into a current or new building water system.

Yet another object of the invention is to provide a method of recuperating waste (blow-down/bleed) water comprising a water reclaim equipment, wherein said water reclaim equipment includes a water conditioning/precipitation equipment and an ultrafiltration equipment, and wherein the water in the blow-down/bleed line is redirected in a manner such that it must always go through said recuperation equipment, thus avoiding the dumping of said water into the sanitary drain.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiment of the invention.

FIG. 1 is a diagram of the boiler water recuperation first embodiment in accordance with the principles of the present disclosure.

FIG. 2 is a diagram of the cooling tower water recuperation first embodiment in accordance with the principles of the present disclosure.

### DESCRIPTION OF THE PREFERRED EMBODIMENT

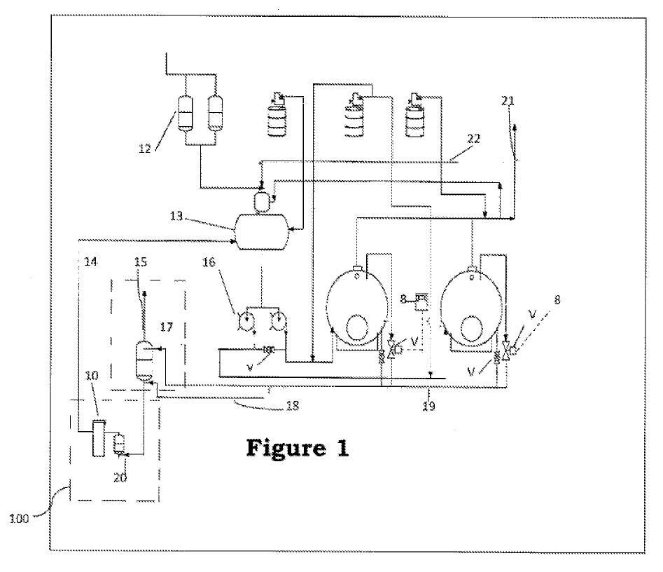

FIG. 1 is directed to the first embodiment of the present invention including a boiler system including the water recuperation equipment or water reclaims system. Mainly the boiler system of FIG. 1 provides a stream of hot water to the facilities through line 21. Several conducts serve as a path from the boiler to the blow-down lines 19. Water at the blow-down lines 19 is directed to a heat exchanger system, wherein said heat exchanger system comprises at least a pump and a heat exchanger 17, wherein said heat changer may receive cooling water 18 and is provided with ventilation 15. After the water directed from the blow-down lines is exposed to the heat exchanger it is directed to the water recuperation equipment. The water recuperation equipment 100 comprises at least a water conditioning/precipitation equipment 20 coupled to water filtration equipment 10, wherein said water filtration equipment is an ultrafiltration equipment. One of the benefits of providing an ultrafiltration equipment is reusing waste (blow-down/bleed) water but at the same time removing unwanted residues that may damage the boiler system. Reusing waste (blow-down/bleed) water reduces costs and at the same time provides a better analysis on residues, more particularly on pipes use for directing said waste (blow-down/bleed) water to the sewers.

The waste (blow-down/bleed) water is treated by the water recuperation equipment and redirected and stored at a feed-water tank 13. Water is then pumped out of the feed-water tank 13 to the boilers by at least one feed pump 16. Condensate water 22 from the facilities and pre-treatment make-up water 12 is directed to the feed-water tank 13. The system is controlled by a control system comprising PLC (Programmable Logic Controller), treatment controller, sensors and timers. The flow of water is manipulated by several valves V, wherein said valves V are controlled by controller system 8. Having water recuperation equipment 100 located after a heat exchanger 17 makes the system more efficient because more particles and residues are added to waste material due to environment exposure at this step of the process in multiple cases. Therefore locating water recuperation equipment after a heat exchanger helps to react with incoming feed-water hardness and prevent it from precipitating on the boiler metal, eliminates any suspended matter such as hardness sludge in the boiler, provides protection to the boiler, eliminates oxygen from the feed-water, and prevents corrosion of the boiler and the steam-condensate systems.

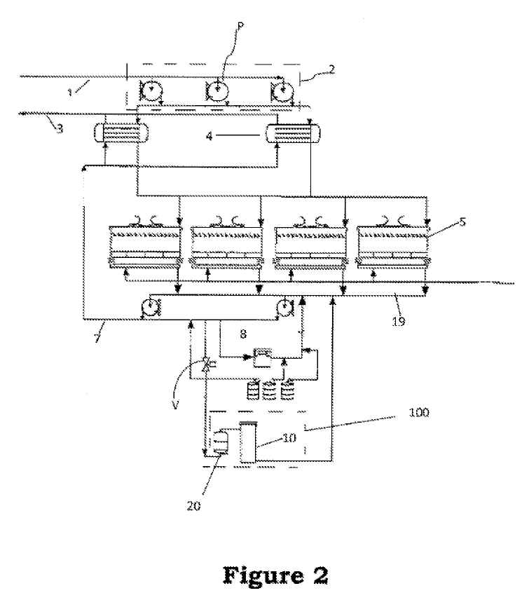

FIG. 2 is directed another system that generates waste (blow-down/bleed) water. Particularly, this exemplary embodiment of the present invention includes a cooling tower system including the water recuperation equipment 100. Water is directed from the facilities 1 toward the chiller/heat exchangers 4 by means of several pumps P. After the chiller 4 the water is redirected to the cooling towers 5. Several conducts serve as a path from the cooling tower to the blow-down lines that are directed to a water recuperation equipment. Similar to the previous embodiment, the water recuperation equipment comprises at least a water conditioning/precipitation equipment 20 coupled to a water filtration equipment 10, as mentioned above. The water is treated by the water recuperation equipment and redirected to the chillers before reaching the facilities 3. The system is controlled by a control system 8 comprising PLC, treatment controller, sensor and timers. The flow of water is manipulated by several valves V also controlled by control system 8. The control system 8 generates signals in order to open or close the valves depending on the reading of several sensor, wherein said reading is compared to a predetermined value. The values V, program for the controlled system 8 and type of sensor may vary depending on the task.

Similar to the first embodiment the location of the water recuperation equipment 100 is important since the second embodiment system will be more efficient when the particles and residues are added to waste material due to environment exposure are eliminated on the presented process in multiple cases.

As shown in the previous exemplary embodiments, the configuration of the components in the water recuperation equipment must always be the same in order for the method of the present invention to be effective. First, the waste (blow-down/bleed) water goes through a precipitation/conditioning process to separate solids and then to a filtration process to remove said solids, reducing the conductivity levels of said water and making is usable for the water state changing system again. It is necessary for the water to pass through the precipitation/conditioning process before being filtered, as the separated solids need to be discarded before allowing the water back into the main circulation line to avoid damage to the rest of the equipment in the system. This method avoids the dumping of oversaturated water through a drain and reduces the amount of make-up water necessary by a system, without the pressure requirements of osmosis or chemical regeneration. Using this method, once the control system determines that the water in the system has reached a specified level of saturation of dissolved solids, instead of dumping and replacing said water, it is reused by the system.

While the invention has been described as having a preferred design, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A method for reclaiming water destined for disposal in a water state changing system, comprising the steps of:
establishing, through a control system, an acceptable level of saturation of dissolved solids in the water running through a main circulation line of said water state changing system;
monitoring, through said control system, the level of saturation of dissolved solids in said water running through said main circulation line of said water state changing system;
detecting, through said control system, when said water is over said acceptable level of saturation of dissolved solids and therefore becomes waste water destined for disposal through a blowdown line;
redirecting said waste water from said blowdown line to a water conditioning/precipitation system;
receiving and processing said waste water by said precipitation system;
directing, after processing by said conditioning/precipitation system, said waste water to a water filtration system;
receiving and processing said waste water by said filtration system, turning said waste water into water with an acceptable level of saturation of dissolved solids;
without discarding any water, reincorporating said water with an acceptable level of saturation of dissolved solids to the main circulation line of said water state changing system.

2. The method as in claim 1, wherein water state changing system comprises a boiler system.

3. The method as in claim 1, wherein water state changing system comprises a cooling tower system.

4. The method as in claim 1, wherein said filtration system is an ultrafiltration system.

5. The method as in claim 1, wherein said acceptable level of saturation of dissolved solids may be modified through said control system.

6. The method as in claim 1, wherein said waste water is processed through a heat exchanging system before being redirected to said water conditioning/precipitation system.

7. The method as in claim 1, wherein said control system comprises Programmable Logic Controllers, and a plurality of sensors and timers.
